(19) United States
(12) Patent Application Publication
(10) Pub. No.: US 2004/0156146 A1
(43) Pub. Date: Aug. 12, 2004

(54) Circuit board, disk apparatus and methods of identifying a head IC

(75) Inventors: Satoshi Nakano, Ome-shi (JP); Yasumasa Kawai, Tachikawa-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/769,924

(22) Filed: Feb. 3, 2004

(30) Foreign Application Priority Data
Feb. 5, 2003 (JP) 2003-028269

(51) Int. Cl. G11B 17/00

(52) U.S. Cl. 360/264.2

(57) ABSTRACT

An HDD, in which a magnetic head is moved in a substantially radial direction of a rotating magnetic disk to record and reproduce data on and from the disk, has an FPC that has a head IC. The FPC has a board and a flexible cable. The board has three chip resistors and a connector pin. The head IC is mounted on the distal end of the flexible cable. To identify the head IC, a probe of an inspection apparatus is connected to the connector pin, thereby to measure the impedance of the chip resistors.

### CROSS-REFERENCE TO RELATED APPLICATIONS

This application is based upon and claims the benefit of priority from the prior Japanese Patent Application No. 2003-028269, filed Feb. 5, 2003, the entire contents of which are incorporated herein by reference.

### BACKGROUND OF THE INVENTION

1. Field of the Invention

The present invention relates to a circuit board with a head IC, a disk apparatus comprising the circuit board, and a method of identifying a head IC.

2. Description of the Related Art

Methods of identifying circuit boards of various types are known. In which method, jumpers are provided on each board to identify the board and a numeral, i.e., 0, 1, 2, . . . , or 9 is displayed in seven segments. Such a method is disclosed in, for example, Jpn. Pat. Appln. KOKAI Publication No. 9-237945, paragraph [0033] and FIG. 2. In the method disclosed in the publication, check pins are brought into contact with at most seven jumpers, respectively. Then, it is determined whether a current flows in the check pins is determined, thereby to identify the circuit board.

The conventional method can identify, but ten types of circuit boards, i.e., 0th to 9th types only. In view of this, it is not so practically useful.

If the conventional method is used to identify circuit boards, each circuit board needs to have a large area to accommodate at most seven jumpers. The circuit board must be inevitably large. As a consequence, any apparatus incorporating the circuit board cannot be small.

In the method described above, it is necessary to determine whether all jumpers required have been attached to the circuit board. That, is, a check pin must be set into contact with seven display segments one by one. It takes much time and labor to examine the check pins.

### BRIEF SUMMARY OF THE INVENTION

According to an embodiment of the invention, there is provided a circuit board having a head IC, a disk apparatus comprising the circuit board, and a method that can easily and reliably identify a head IC by the use of a simple structure.

A circuit board according to an embodiment of the invention comprises: a board unit; a head IC; at least one resistor element which has an impedance for identifying the head IC; and a connection terminal to be connected to an inspection apparatus which measures the impedance of the at least one resistor element.

An disk apparatus according to an embodiment of the invention comprises: a spindle motor which supports and rotates a disk-shaped medium; a suspension arm having a distal end; a head which is provided on the distal end of the suspension arm and which records and reproduces data on and from the medium; a voice coil motor which rotates the suspension arm to move the head in a substantially radial direction of the medium; and a circuit board having a board unit, a head IC, at least one resistor element which has an impedance for identifying the head IC, and a connection terminal which is used to measures the impedance of the at least one resistor element.

A method of identifying a head IC, according to an embodiment of the invention, comprises: connecting an inspection apparatus to a connection terminal of a circuit board which has at least one resistor element having an impedance for identifying the head IC and a connection terminal connected to the at least one resistor element; connecting an inspection apparatus to the connection terminal; and measuring the impedance of the at least one resistor element to identify the head IC.

In an embodiment of the invention, the head IC can be identified by merely connecting the inspection apparatus to the connection terminal that is connected to the at least one resistor element. Hence, the head IC can be automatically identified, both easily and reliably.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exploded perspective view showing an HDD according to an embodiment of the present invention;

FIGS. 2A and 2B are exploded perspective view illustrating a structure incorporated in the HDD shown in FIG. 1;

FIG. 3 is a plan view depicting the FPC of the structure illustrated in FIGS. 2A and 2B;

FIG. 4 is a circuit diagram of the chip resistors provided in the FPC of the structure shown in FIGS. 2A and 2B; and

FIG. 5 is a block diagram of an inspection apparatus that is connected to the connector pins included in the FPC of FIG. 3.

### DETAILED DESCRIPTION OF THE INVENTION

An embodiment of the present invention will be described in detail, with reference to the accompanying drawings.

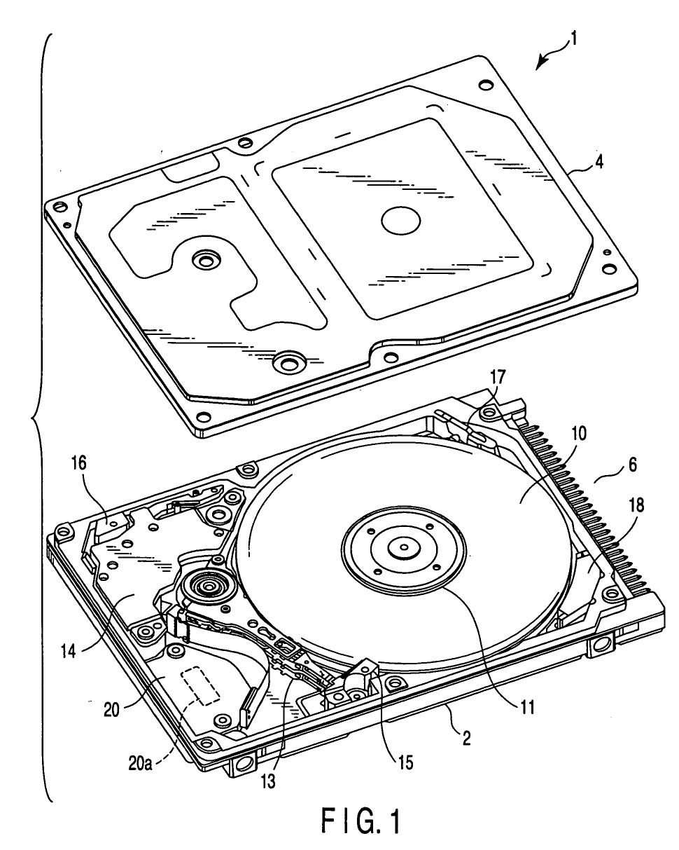

FIG. 1 is an exploded perspective view that schematically shows a hard disk drive 1 (disk apparatus, hereinafter called “HDD 1”) according to the embodiment of the invention.

The HDD 1 has a substantially rectangular housing 2 and a top cover 4. The housing 2 opens at the top. The top cover 4 fastened with screws (not shown) to the top of the housing 2. A gasket (not shown) is interposed between the housing 2 and the top cover 4.

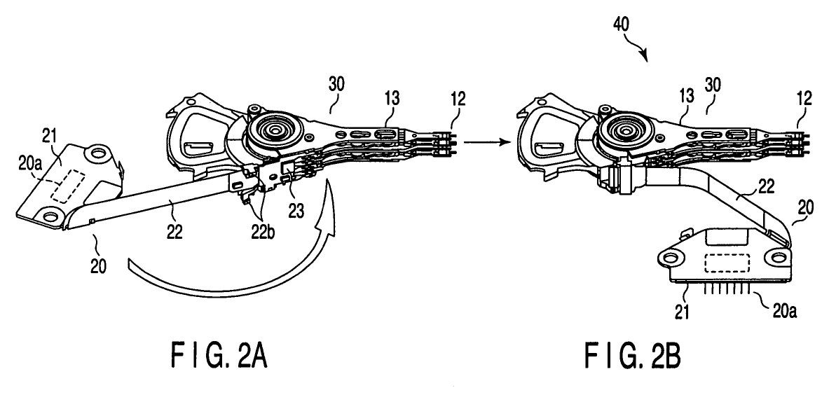

The housing 2 contains two magnetic disks 10 (disk-shaped recording media), a spindle motor 11, a plurality of magnetic heads 12 (heads, see FIGS. 2A and 2B), and a plurality of suspension arms 13. The housing 2 further contains a voice coil motor 14, a ramp load mechanism 15, an inertia latch mechanism 16, a circulation filter 17, a respiration filter 18, and a printed circuit board 20 (hereinafter referred to as “FPC 20”). The spindle motor 11 supports and rotates the disks 10. The magnetic heads 12 can record and reproduce data on and from the magnetic disks 10. The suspension arms 13 support, at distal end, the magnetic heads 12. The voice coil motor 14 rotates the arms 13 to move the heads 12 in the radial direction of the disks 10. The ramp load mechanism 15 holds the heads 12 in a safety position outside the magnetic disks 10, when necessary. The inertia latch mechanism 16 prevents the magnetic head 12 from moving from the safety position when they are vibrated. The circulation filter 17 traps dusts in the housing 2. The respiration filter 18 traps dust in the air introduced into the housing 2. The FPC 20 has a head IC mounted on it. The head IC will be described later.

A board unit (not shown) is secured to the back of the housing 2. A connector 6 extends from the board unit and protrudes form one end of the housing 2. The connector 6 has a plurality of pins. The pins may be electrically connected to an external apparatus. A connector 20a (see FIG. 2B) is exposed at the back of the housing 2. This connector 20a has a plurality of pins, which project from the FPC 20.

To record and reproduce data on and from the magnetic disks 10, the spindle motor 11 rotates the disks 10. The suspension arms 13 are rotated, moving the magnetic heads 12 to the target tracks (not shown) provided on the disks 10.

FIGS. 2A and 2B show a structure 40 that comprises the FPC 20 and a head stack assembly 30 (hereinafter referred to as “HSA 30”). The HSA 30 comprises the suspension arms 13. The FPC 20 is connected to the HSA 30. The structure 40 is incorporated in the housing 2 of the HDD 1, in the state illustrated in FIG. 2B.

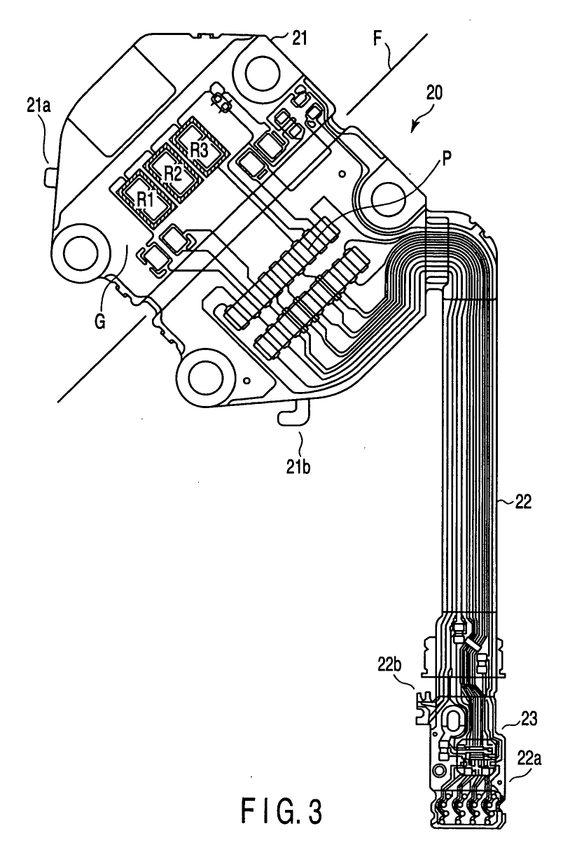

As shown in FIG. 3 in detail, the FPC 20 has a board 21 and a long flexible cable 22 (cable). The cable 22 extends from the board 21. A head IC 23 is mounted on the end portion 22a of the cable 22, which is remote from the board 21. The end portion 22a of the cable 22 is secured to the HSA 30, thus connecting the head IC to the HSA 30. The FPC 20 is connected to the HSA 30.

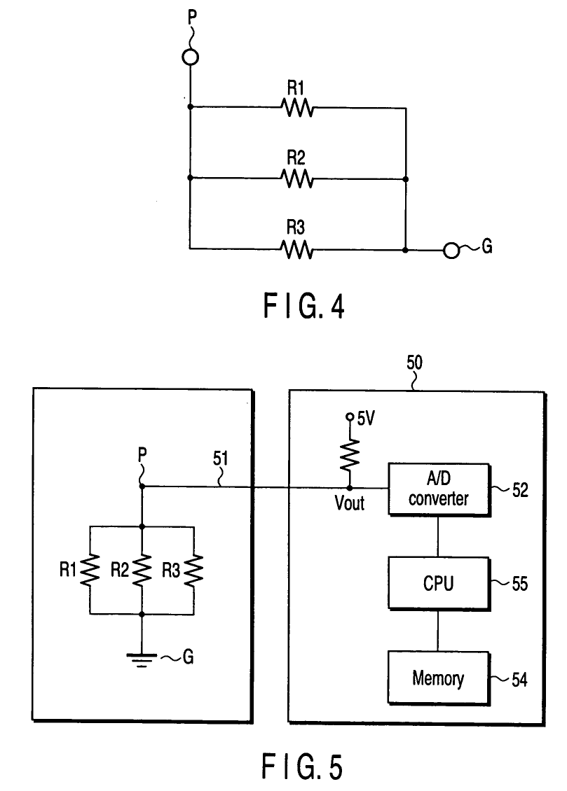

Three chip resistors R1, R2 and R3 (resistor elements) are mounted on the board 21. The resistors R1, R2 and R3 have impedance assigned to the head IC 23. Hence, the resistors R1, R2 and R3 serve to identify the head IC 23. As FIGS. 3 and 4 show, the chip resistors R1, R2 and R3 are connected in series, forming a series circuit. The series circuit is connected at one end to the ground and at the other end to a connector pin P (connection terminal). The connector pin P is electrically connected to the connector 20a.

The board 21 is folded along a centerline F so that the chip resistors R1, R2 and R3 may be exposed. Thus, once the board 21 has been so folded, the resistors R1, R2 and R3 are exposed outside.

Two claws 21a and 21b are formed integral with the board 21 and project from two edges opposing across the centerline F. When the board 21 is folded along the centerline F, the claws 21a and 21b latch each other. Once after the claws 21a latch each other, the FPC 20 remains folded as illustrated in FIGS. 2A and 2B.

After the FPC 20 is secured to the HSA 30 as shown in FIG. 2A, the cable 22 is folded at its end portion 22a, in the direction of the arrow shown in FIG. 2A. Then, the two claws 22b provided on the end portion 22a engage with the HSA 30 and are fastened to the HSA 30. The head IC 23 mounted on the end portion 22a of the cable 22 can be seen from outside, because it is covered with resin.

FIG. 5 is a block diagram showing an inspection apparatus 50 for identifying the head IC 23. The apparatus 50 comprises a probe 51, an A/D converter 52, a CPU 55, and a memory 54. The probe 51 is electrically connected to the connector pin P of the FPC 20 provided in the structure 40. It is secured to the HSA 30. The inspection apparatus 50 applies a reference voltage of, for example, 5 V, to the chip resistors R1 to R3. In the apparatus 50, the A/D converter 52 measures the impedance of the chip resistors R1 to R3. The CPU 55 correlates the impedance with the data stored in the memory 54, thereby identifying the head IC mounted on the FPC 20.

It will be described how the head IC is identified in the course of manufacturing the HDD 1.

As shown in FIG. 3, the chip resistors R1 to R3 that serve to identify the head IC can be seen from outside before the board 21 is folded. The chip resistors R1 to R3 can be identified from their outer appearances, such as shape, color, patterns and ID numbers.

The inspection apparatus 50 is connected to the structure 40 so assembled as shown in FIG. 2B, making it possible to identify the head IC 23. More precisely, the probe 51 of the apparatus 50 is connected to the connector pin P provided on the board 21 of the FPC 20. The impedance of the chip resistors R1 to R3 is measured, thereby identifying the head IC 23. The connector pin P is exposed outside once the board 21 of the FPC 20 has been folded as shown in FIGS. 2A and 2B.

In the method according to this embodiment, the head IC 23 can be identified by only connecting the probe 51 of the apparatus 50 to the connector pin P. That is, a simple structure can identify the head IC 23 that is invisible, easily and reliably.

After the structure 40 of FIG. 2B is held in the housing 2 of the HDD 1, the connector 20a protruding from the housing 2 may be connected to a dedicated inspection apparatus (not shown) to identify the head IC 23 secured to the HSA 30. Once the structure 40 has been set in the housing 2, the pins of the connector 20a are exposed outside the housing 2. Thus, the inspection apparatus can be electrically connected to the connector 20a from outside of the housing 2.

In this embodiment, the structure 40 can be connected to the inspection apparatus 50 after the FPC 20 is secured to the HSA 30 in the course of manufacturing the HDD 1. This makes it possible to identify the head IC 23 that is not visible from outside the structure 40. Further, the HDD 1 can be connected to a dedicated inspection apparatus to identify the head IC 23. Namely, the head IC can be identified in the present embodiment by the inspection apparatus that is an automatic one.

The head IC 23 that is invisible can be reliably identified In the present embodiment, only by connecting the inspection apparatus to the structure 40 or the HDD 1.

With the present embodiment it is possible to change the impedance to any desired value, merely by changing the resistances of the chip resistors R1 to R3. This is useful in practice because the number of patterns, with which the head IC may be identified, can therefore be increased.

The FPC 20 of this embodiment needs but a relatively small space in which the chip resistors R1 to R3 and the connector pin P are arranged. The apparatus need not be greatly changed in configuration. It would not become large.

The invention is not limited to the embodiment described above. Various changes and modifications can be made within the scope and spirit of the invention. For example, the number of chip resistors can be changed, from three, i.e., chip resistors R1 to R3 used in the embodiment to identify the head IC 23. Further, the chip resistors can be changed, if required, in shape, size, position and the like.

The above embodiment is designed to identify the head IC 23 provided in the HDD 1. Nonetheless, the invention can be used to identify the printed circuit board 20 of the HDD1 or the ICs that are mounted on the printed circuit board of any other electronic apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A circuit board having:
a head IC;
at least one resistor element which has an impedance for identifying the head IC; and
a connection terminal to be connected to an inspection apparatus which measures the impedance of said at least one resistor element.

2. The circuit board according to claim 1, further having a board which holds said at least one resistor element, and a cable which connects the head IC to the board, with the head IC spaced from the board.

3. The circuit board according to claim 1 or 2, wherein said at least one resistor element has an outer appearance which serves to identify said at least one resistor element.

4. The circuit board according to claim 2, wherein the board is folded in a direction to expose said at least one resistor element.

5. A disk apparatus comprising:
a spindle motor which supports and rotates a disk-shaped medium;
a suspension arm having a distal end;
a head which is provided on the distal end of the suspension arm and which records and reproduces data on and from the medium;
a voice coil motor which rotates the suspension arm to move the head in a substantially radial direction of the medium; and
a circuit board having a head IC, at least one resistor element which has an impedance for identifying the head IC, and a connection terminal which is used to measures the impedance of said at least one resistor element.

6. The disk apparatus according to claim 5, wherein the circuit board further has a board which holds said at least one resistor element, and a cable which connects the head IC to the suspension arm, with the head IC spaced from the board.

7. The disk apparatus according to claim 6, wherein the board unit is folded in a direction to expose said at least one resistor element and is secured to the disk apparatus.

8. The disk apparatus according to claim 5, which further comprises a housing containing the spindle motor, the suspension arm, the voice coil motor and the circuit board, and in which the connection terminal is electrically connected to a connector protruding outwards from the housing.

9. A method of identifying a head IC comprising:
connecting an inspection apparatus to a connection terminal of a circuit board which has a head 2C at least one resistor element having an impedance for identifying the head IC and a connection terminal connected to said at least one resistor element; and
measuring the impedance of said at least one resistor element to identify the head IC.

10. The method according to claim 9, wherein the inspection apparatus is connected to a connector of a disk apparatus the impedance of said at least one resistor element is measured, thereby to identify the head IC, said disk apparatus comprising a housing, a spindle motor provided in the housing and configured to support and rotate a disk-shaped medium, a suspension arm provided in the housing and having, on a distal end, the head IC and a head for recording and reproducing data on and from the medium, and a voice coil motor provided in the housing and configured to rotate the suspension arm to move the head in a substantially radial direction of the medium, said circuit board being provided in the housing after inspected, and said connector being electrically connected to the connection terminal and led outwards from the housing.
